(19) United States
(12) Patent Application Publication
(10) Pub. No.: US 2013/0217416 A1
(43) Pub. Date: Aug. 22, 2013

(54) CLIENT CHECK-IN

(71) Applicant: Microsoft Corporation, (US)

(72) Inventors: Joseph H. Matthews, III, Woodinville, WA (US); Joseph A. Schrader, Kirkland, WA (US); Ted Tai-Yu Chen, Seattle, WA (US); Raman K. Sarin, Redmond, WA (US); Gregory Howard A., Kirkland, WA (US)

(73) Assignee: Microsoft Corporation, Redmond, WA (US)

(21) Appl. No.: 13/726,031

(22) Filed: Dec. 22, 2012

Related U.S. Application Data
(60) Provisional application No. 61/580,119, filed on Dec. 23, 2011.

(51) Int. Cl. H04W 4/02

(52) U.S. Cl. CPC H04W 4/025
USPC 455/456.2; 455/456.3

(57) ABSTRACT

Client check-in techniques are described. In embodiments thereof, a mobile device includes a communication interface for notification communication with one or more other devices associated with the mobile device. The mobile device has a selectable control for user selection to initiate a check-in notification that indicates a location of the mobile device and a timestamp of the date and time. The mobile device also includes a check-in service that is implemented to initiate communication of the check-in notification to the other associated devices responsive to a user selection to initiate the check-in notification.

### RELATED APPLICATION

This application claims priority under 35 U.S.C. Section 119(e) to U.S. Provisional Patent Application Ser. No. 61/580,119 filed Dec. 23, 2011 entitled “Mobile Device Check-In”, the disclosure of which is incorporated by reference herein in its entirety.

### BACKGROUND

Many types of devices, such as mobile phones, tablet devices, and other computing, communication, and entertainment devices increasingly offer more functions, applications, and features which are beneficial to a user, and can enhance one's personal time as well as work and social activities. For example, children can let their parents know by text message or with a phone call from a mobile phone their whereabouts or that they have safely arrived at a particular destination.

Thus, users may contact a variety of different people using a variety of different techniques, such as phone calls, email, instant messages, status updates, share pictures, and so on. Further, users may desire to interact with different collections of the people at any one time. Accordingly, it may be difficult using conventional techniques to interact with the variety of different people using the variety of different techniques.

### SUMMARY

Client check-in techniques are described. In embodiments thereof, a mobile device includes a communication interface for communication with other devices that are associated with the mobile device. The mobile device has a selectable control for user selection to initiate a check-in notification that indicates a location of the mobile device and a timestamp of the date and time when the check-in notification is initiated. The device also includes a check-in service that is implemented to initiate communication of the check-in notification to the other associated devices responsive to a user selection to initiate the check-in notification.

A check-in notification can be generated as a Uniform Resource Locator (URL) that includes latitude, longitude, and a timestamp embedded in the URL. An associated device that receives the check-in notification as a URL can perform a security and/or authenticity check of the received check-in notification in an effort to verify that the check-in notification has not been spoofed or tampered with. The associated device that receives the check-in notification can also display the location from which the check-in was initiated on a map that is displayed on the device, such as in a browser application user interface. The location can be displayed as a “push-pin” point-of-interest (POI) on the map, and a friend can then tap or otherwise select the location that is displayed on the map and be provided with directions from the friend's current location to the location of the person sending the check-in notification.

This Summary introduces features and concepts of mobile device check-in, which is further described below in the Detailed Description and/or shown in the Figures. This Summary should not be considered to describe essential features of the claimed subject matter, nor used to determine or limit the scope of the claimed subject matter.

### BRIEF DESCRIPTION OF THE DRAWINGS

Embodiments of mobile device check-in are described with reference to the following Figures. The same numbers may be used throughout to reference like features and components that are shown in the Figures:

FIG. 1 illustrates an example environment in which various embodiments of client check-in can be implemented;

FIG. 2 illustrates examples of private interaction hub interfaces, showing two different examples of hubs for a family;

FIG. 3 depicts a system in an example implementation in which the hub check-in service of FIG. 1 is implemented “over the cloud” as part of a network service;

FIG. 4 is a flow diagram depicting an example procedure involving client device check-in;

FIG. 5 is a flow diagram depicting another example procedure involving client device check-in;

FIG. 6 is a flow diagram depicting yet another example procedure involving client device check-in;

FIG. 7 illustrates an example system in which embodiments of private interaction hubs can be implemented;

FIG. 8 illustrates another example system in which various embodiments of the previously described techniques can be implemented;

FIG. 9 further illustrates the various client device services that are described with reference to the previous sections; and

FIG. 10 illustrates an example system that includes an example device, which can implement embodiments of private interaction hubs.

### DETAILED DESCRIPTION

Client device check-in techniques are described. In one or more example, techniques involving a hub are described that support communication between members of the hub to share content. A hub, for instance, may be specified for a family and thus family members may join the hub to share content, such as messages, photos, and so on. A variety of other hubs may also be configured, such as for employees, friends, and so on. Thus, sharing of content may be performed to members of the hub as a whole instead of involving individual communications as previously required using conventional techniques.

The hub may be utilized to support a wide variety of functionality. One example of this functionality is a hub check-in service in which members can “check in” with each other regarding a location of the members. A daughter included in a family hub, for instance, may utilize this functionality to inform other members of the family hub (e.g., parents, siblings, and so on) the she has arrived safely at school. Thus, in this example, the family hub may be used to disseminate messages to other members of the hub in an efficient and intuitive manner. Other examples are also contemplated, such as to share photos and so on. Further discussion of these and other examples may be found in relation to the following sections.

A check-in notification can be initiated by a user of a mobile device, such as mobile phone, and the device communicates the check-in notification to other devices that are associated with the mobile device, such as to the devices belonging to the family members or friends of the person sending the check-in notification. The check-in notification can be generated as a Uniform Resource Locator (URL) that includes latitude, longitude, and a timestamp embedded in the URL. Optionally, the check-in notification may include an identifier of the mobile device from which the check-in notification is initiated and/or an identifier of the user of the mobile device. Alternatively, the communication service utilized to communicate the check-in notification can determine and correlate the device and/or user identifiers, without including the identifiers as part of the URL of the check-in notification. For example, a location shared via SMS does not include an identifier, but the receiving device can identify the sending device from the SMS message.

The check-in notification can then be communicated to the recipient devices utilizing any number of communication transport techniques and/or communication services, to include SMS, MMS, instant messaging, or a chat message. A receiving device, such as a family member or friend's device, may perform a security and/or authenticity check of the received check-in notification in an effort to verify that the check-in notification has not been spoofed or tampered with, and indicates the actual location at the corresponding date and time of the person sending the check-in notification.

A family member or friend that receives the check-in notification (e.g., at each person's own device) can then view the location on a map that is displayed on the device, such as in a browser application user interface. The location can be displayed as a “push-pin” point-of-interest (POI) on the map. A friend can then tap or otherwise select the location that is displayed on the map and be provided with directions from the friend's current location to the location of the person sending the check-in notification.

While features and concepts of the hub check-in service can be implemented in any number of different devices, systems, networks, environments, and/or configurations, embodiments are described in the context of the following example devices, systems, and methods.

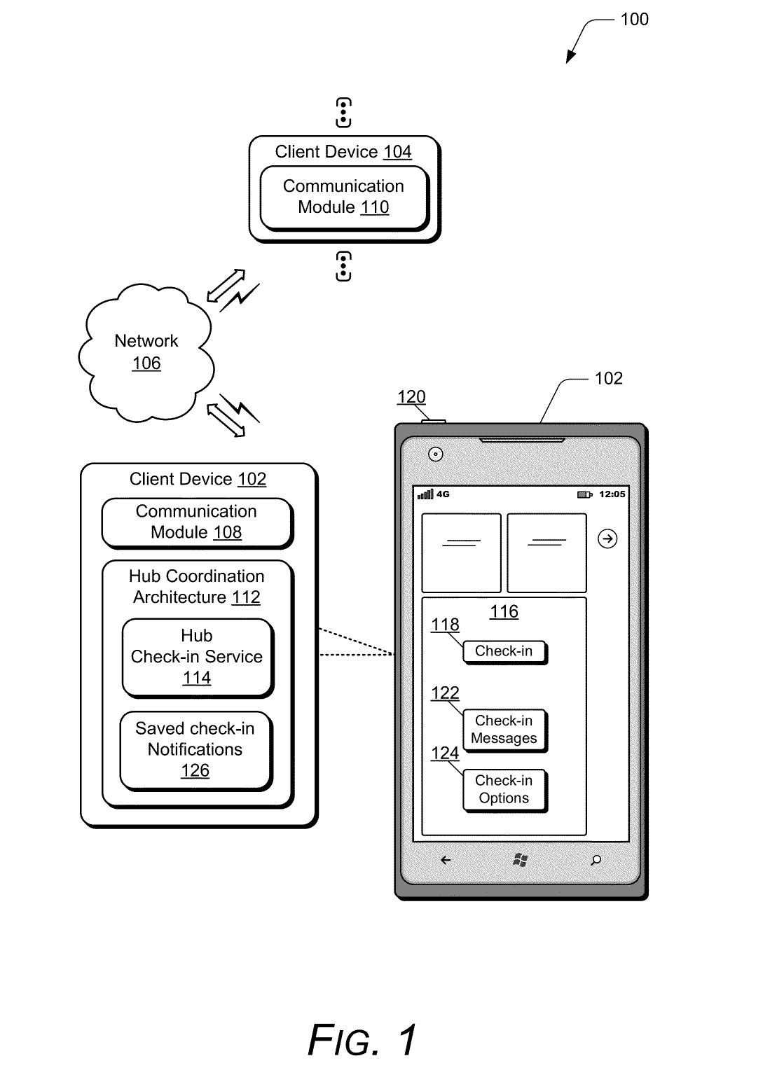

FIG. 1 illustrates an example environment 100 in which various embodiments of device check-in can be implemented. The example system includes a client device 102 communicatively coupled to another client device 104 via a network 106. The client devices 102, 104 may be configured according to a variety of different computing device configurations. In the illustrated example, the client device 102 is configured as a mobile device, such as a mobile phone or tablet device, although other mobile device configurations are also contemplated, such as a communication device, convertible device, entertainment, gaming, navigation, and/or other type of portable electronic device. The client devices 102, 104 may also assume a variety of other computing device configurations, such as traditional PCs, laptops, and so on. Although a single instance of the client device 104 is illustrated, this device may be representative of a plurality of different devices and thus reference in the following discussion may be made to client device 104 in single or in plural form. Additional examples of functionality that may be incorporated as part of the client device 102, 104 may be found later in the discussion.

The client devices 102, 104 are illustrated as including respective communication modules 108, 110. The communication modules 108, 110 are representative of functionality of the devices to communicate via the network 106, such as to communicate with each other. The communication modules 108, 110 may perform this communication using a variety of techniques, such as to support voice communication, text messaging (e.g., SMS, MMS), instant messaging, communication via a social network service, email, and so on. Accordingly, the client device 102, 104 may utilize a variety of different techniques to communicate with each other.

The client device 102 is also illustrated as supporting a hub coordination architecture 112. The hub coordination architecture 112 is representative of functionality to provide a hub that supports communication between members of the hub to interact and share data, as described further herein. The hub, for instance, may support a user interface via which users of the client device 102, 104 may share content based on membership to the hub. A variety of different content may be shared via the hub, such as messaging, photos, check-ins, links, background image of the hub, and so on.

As illustrated in FIG. 1, the hub coordination architecture may include a hub check-in service 114. The hub check-in service 114 provides the functionality to share data indicating a location of a member of a hub with other members of the hub. In this way, members of a hub can “check in” with each other regarding a location of the members. A daughter included in a family hub, for instance, may utilize this functionality to inform other members of the family hub (e.g., parents, siblings, and so on) the she has arrived safely at school. Thus, in this example, the family hub may be used to disseminate messages of other members of the hub in an efficient and intuitive manner. Other examples are also contemplated, such as to share check-in data between members of a workgroup to monitor employees and so forth.

The hub check-in service 114, for instance, may be used to communicate a geographic location (e.g., latitude/longitude coordinates, cell phone tower, street location, zip code, or landmark information) along with a timestamp and identifier of the user using the client device 102 to another client device 104. The other client device 104, for instance, may also be a member of a hub to which a user of client device 102 belongs. This communication may be performed in a variety of ways, such as encoded as part of a URL and then communicated via text message, instant message, email, and so forth, as described further herein. In some examples, the communication is performed by initiating the transmission of an SMS, MMS, instant message, or other type of message that includes an encoded URL to a website that provides descriptive information about the particular location (e.g., street map information, directions, etc.). The URL used may embed additional information that could be interpreted by the receiving device 104, e.g., by embedding a timestamp, user or device identity, or other information. Additionally, while implementations are described to encode location and a timestamp in a URL (such that a device that doesn't “understand” the location format can still launch a browser to consume it), such data could clearly be encoded in any number of ways, not limited to the “plaintext,” URL, and/or audio/video or other proprietary formats. Further, check-ins should not be considered bound by the limitations of these more “human-readable” formats described herein, as opposed to generally data in a generic format (e.g., a “blob” of data) that all client devices can learn to recognize and convert.

When the other client device 104 receives the communicated geographic location, it may display an indication of the user's location, e.g., in a hub user interface of a hub application (e.g., as a thumbnail image), in a mapping location application, in a notification center, and/or in a messaging application. For example, the other client device 104 may display a URL received in a message that is selectable by a user. As another example, the other client device 104 may recognize the URL, interpret the URL and the information embedded in the URL, and assimilate into a user interface additional information (e.g., graphical maps or directions) obtained from a website that provides descriptive information about the particular location. Selection of the indication of the user's location by a user of client device 104 may then cause the output of a map indicating a location of client device 102. A variety of other functionality may be supported, such as to output directions upon a “tap” of the user's location such that a user of client device 104 may journey to a geographic location of client device 102, and so on. The output of the map, for instance, may be performed using a browser or mapping application, may be performed as part of the hub coordination architecture 112 as further described later in the discussion, and so on. Thus, although described as part of the hub, various embodiments of the client check-in service may be implemented or integrated independently of a hub.

In the example environment 100, hub check-in service 114 may be configured to include a coordination feature that allows hub members to “check-in” with one or more of the other members to notify the membership of a safe arrival at a destination, or departure from any given location using geo-location features of the user's phone. A hub member can be prompted to check-in through synchronization with the shared calendar or by manual request received from another member.

Various check-in and/or check-back responses can be implemented to respond to the other members. Further, if a member fails to check-in at a designated time or if requested by another member, the user's client device can send an automatic geo-location notification to the others and/or to the family hub. In the same way that text messaging can be more efficient than a phone call, the check-in feature is designed to address the same necessity, but may be more efficient and timely than manually providing a textual description of a person's location via text messaging. The check-in feature can be implemented as a user interface and/or client device application or service. Embodiments of check-in include any one or combination of implementation features, such as described in the following paragraphs.

Check-in can be implemented for hub members with mobile devices to share time-stamped geo-location data. When a user selects the check-in command, a notification is transmitted from that user's client device to the set of connected users and client devices associated with that user. For example, if a Teen arrives at her High School's away football game in another city, she can simply select “Check-in” and notifications will be shared with her Parents and Siblings (e.g., or other designated family members) in a family hub. The notification can also be saved and displayed for review after the event.

Devices and/or device accounts can be associated within a set of devices or device accounts (e.g., a family phone account, user accounts, a connected set of devices, etc.), and all or a subset of the devices or accounts can communicate with other devices or accounts. The hub check-in control can be any software or hardware based control to initiate the check-in functionality (e.g., text link, icon, or dedicated hardware button), and a hub check-in event can be managed by a software service with connected devices.

A check-in event can include various metadata, such as a user identity (name, nickname, account identifier, etc.), time and date information, a geo-location or geo-friendly name, an image associated with the event, and/or a personalized voice or text message. The metadata is not limited to this list. A check-in user interface can be displayed as a one-click feature. Alternatively, the check-in user interface can be displayed with options to select (e.g., include this text message), or can incorporate settings to control hub check-in user interface options.

Hub member recipients of a check-in event may receive a notification of the event, and the notification can be in any one of many forms and often, multiple forms of notification can be used. Examples include standard system notifications, a Live Tile update (e.g., on a Windows-based Phone or tablet), a hub wall update on the hub user interface, a text message indication, and so forth. Each notification can pull from the data and metadata associated with a check-in event, such as a hub name or identifier, user name of the sender, time stamp, geo-location, and the like.

Check-in event notifications can present additional functionality, such as when selecting a check-in notification. The member may be directed to a corresponding hub user interface, or a text messaging client is opened with the contact information auto-filled to enable quick replies to the originator of the check-in event. These options are configurable by a system designer to enable and offer auto-filled replies for users. In some systems, a hub member (e.g., family member) may have an auto-response sent by system. In other systems, the user may have a choice of response methods enabled by the design of the system, such as a formatted notification response from the one or more other devices that indicates “Dad received your check-in notification.”

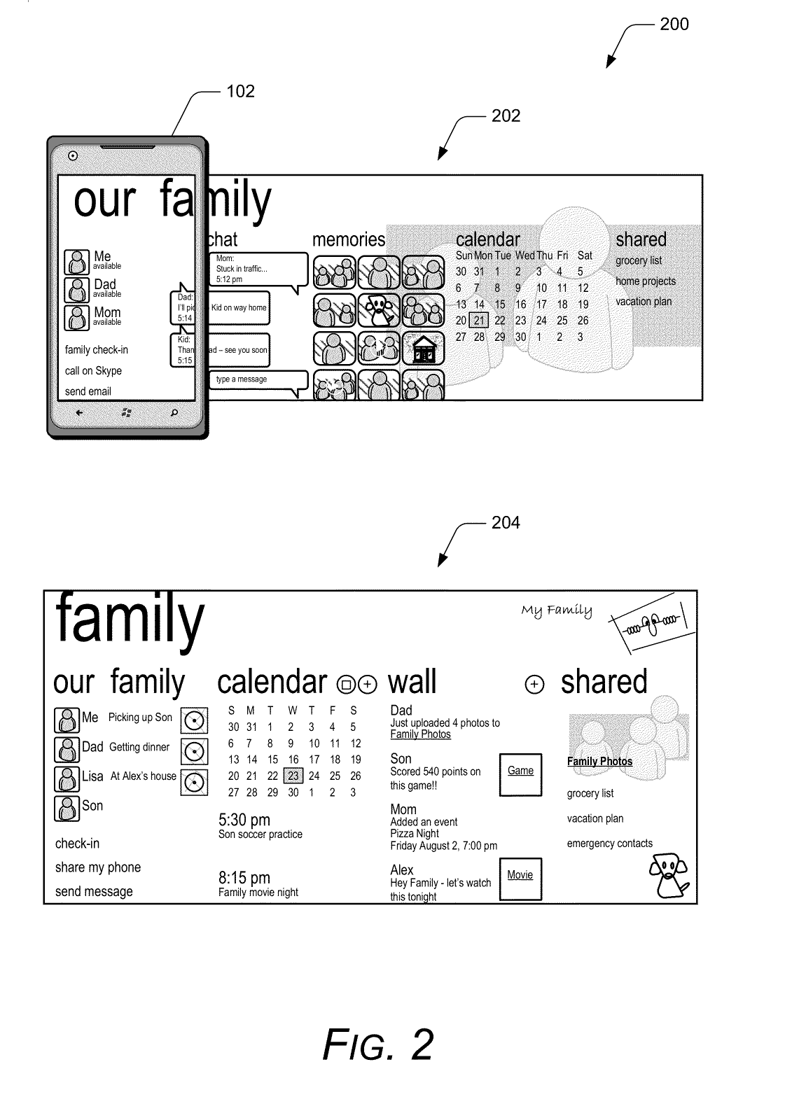

Examples of hub user interfaces 202 and 204 are shown in FIG. 2, and the hub user interface 204 includes an example of check-in functionality, illustrating that a family member has checked in at a location (e.g., “Alex's house”) forty-five minutes ago and a small representation of the map is included with the check-in notification. Below the representations of contacts, the “check-in” verb command is displayed. A check-in event may not simply be a GPS (or other) location update. Options may include notifications of “arrived safely”, “at location but need help”, “did not arrive but safe”, “did not arrive, need help”, and so on.

A check-in notification can be user-scheduled, such as every hour and as an auto-posted update from each connected device. Anyone in the group can receive a check-in notice, and that notification may surface on a device lock-screen if the receiving device is protected by a security mechanism. A one-push touch to initiate a check-in notification can include any one or combination of a message, graphic, text, metadata, audio, an image, video, etc.

If a hub member such as a Teen, Kid, Child, Grandparent, etc. does not check-in, a Parent or other controlling entity can initiate a “peek” to request a check-in or determine a location of the other family member's phone. The kid can then respond to the peek request, without the kid ceding control over when a check-in occurs, or the duration of a check-in's tracking. An auto-trigger can also be implemented as a reminder for a kid to check-in. A parent can also get a reminder that a hub check-in notification should have been received by now. Additionally, if a check-in has not been initiated, the kid's phone can auto-send a notification of location and/or past locations. A parent can also setup to get automatic notifications when a kid arrives at school, leaves school, goes to a friend's house, goes to study, gets home, etc. with hub check-in location-based automation for geographically identified boundaries.

A check-in notification can be initiated as a pattern or code, such as to represent a safeword to parents. The pattern or code message can be converted to a help message. As previously described, check-in is not limited to kids, but may be implemented for a variety of members of a hub, such as employees, aging grandparents, parents that travel, or for any of the hub members for any occasion or event. A check-in can be implemented for a coordinated activities scenario, such as Dad intends to pick up Kid from an event, but the kid has left with his friends. So Dad's phone checks-in to the kid's phone to let the kid know that dad is almost there to pick him up when in proximity to the pick-up location. Then when the Dad and kid's phones are together or proximate, a check-in notification can be sent to Mom that Kid has been picked up. Alternatively, Dad receives a check-in notification if the kid's phone has left the pickup location.

A check-in notification may also include an “I'm checked out” or a “do not disturb sign”. A parent, for instance, may want the babysitter to receive the check-in notice from the kid if the parent designates as such. Hub members can receive a check-in notification if another member does check-in, and can get a check-in notification if the other member does not check-in. A check-in notification can be a remote alarm to receive a message at the right time. For example, a kid gets a text message reminder just as school lets out to remind the kid not to get on the bus, but rather will be picked up today. The check-in button (e.g., a user-selectable control) of the hub check-in feature can be implemented or otherwise embodied in the hub and/or in various system user interfaces, such as displayed on mobile device start and lock screens, as well as any other hub coordination user interfaces.

A check-in user interface 116 can include a selectable control 118 for user selection to initiate a check-in notification that is communicated to associated devices of the device. Alternatively or in addition to the selectable control 118, the mobile device may include a hardware selectable control 120, such as a push button or switch on the device. A check-in notification indicates a location of the mobile device and includes a timestamp of the date and time. The hub check-in service 114 is implemented to initiate communication of the check-in notification to the associated devices responsive to a user selection of the selectable control 118 or the hardware selectable control 120 to initiate the check-in notification.

In this example, the user interface 116 includes a user option to select formatted check-in messages 122, such as “arrived safely”, “at location but need help”, “did not arrive but safe”, “did not arrive”, etc. The user interface 116 also includes a user option to select check-in notification options 124, such as to communicate a check-in notification to the associated devices in different or multiple formats. The hub check-in service 114 is implemented to communicate a check-in notification in multiple formats, such as a text message, an instant message, an audible message, or an image for display at the associated devices. A user may also select to include an image of the location, a map of the location, and/or displayable text.

The hub check-in service 114 at the client device 102 is implemented to save the check-in notifications to a memory of the device (or optionally, at an associated device), and the saved check-in notifications 126 are then reviewable, such as when displayed on the device. The check-in service can initiate a reminder for a user of the device that a check-in notification has not been initiated for communication to the associated devices. For example, a user may arrive at an intended location, but forget to send a check-in notification, and the check-in service can initiate a reminder for the user of the device. The hub check-in service 114 can initiate communication of time-based check-in notifications to the associated devices based on elapsed time intervals, such as a check-in notification every hour or over some other time interval. The check-in service can also initiate communication of location-based check-in notifications to the associated devices based on the device arrival at preset locations.

The hub check-in service 114 at the mobile device 400 can initiate communication of a check-in notification when at least one of the associated devices is proximate the device at the location. For example, Dad associated with client device 104 may arrive at a location to pickup Kid that is associated with client device 102, and each users' devices communicate a check-in notification to the other. The hub check-in service 114 is also implemented to receive check-in notifications from any of the other associated devices, and may initiate communication of a formatted notification response to an associated device from which a check-in notification is received. The hub check-in service 114 can also initiate a reminder at the device that a check-in notification should have been received from an associated device, such as at an approximate time that the user of the associated device was scheduled to arrive at a location. Although the hub check-in service was described as implemented by the client device 102, a variety of other implementations are also contemplated, an example of which is described as follows and shown in relation to the corresponding figure.

FIG. 2 is an example of a system 200 showing two different examples of hub user-interfaces for a family-orientated hub. The description, layout, orientation, features, and organization of the text, images, photos, graphics, links, data, information, and presentation features shown with reference to the hub user interfaces, as well as with reference to any other user interfaces described herein and/or shown in the figures, are merely examples that may be altered in any aspect for various embodiments and/or implementations of mobile device check-in.

The hub is a central space for membership-orientated coordination of communications, activities, information, and integration. Designated member relationships can be utilized to define how the data and information is managed, and can be implemented to leverage the social contract, such as between members of a defined familial group in the illustrated example. In one or more implementations, the hub is implemented as a user interface (e.g., via a client device application) for integration and aggregation of the membership-orientated communications, activities, and information. A hub can be implemented as a private, shared space between defined members. The hub contains links to other members' profiles, and based on restriction settings, allows aggregation for visibility of some of other members' data and information within the hub. The hub shares a group calendar which can be viewed and edited, a common text message window, a posting board, a shared photo album, a check-in feature, and any other type of shared information.

Devices and/or device accounts can be associated within a set of devices or device accounts (e.g., a family phone account, user accounts, a connected set of devices, and so on), and all or a subset of the devices or accounts can communicate with other devices or accounts. The members of a hub can be defined by any number of different classes of people, such as Junior, Teen, Mom, Dad, (or Parent), Grandparent, Nanny, Life-Coach, and so on for the illustrated example of a family. Further, the members of a family can be defined to distinguish a live-in Nanny from a Babysitter, for example.

Additionally, membership of the hub as well as use of the hub by the members can be controlled by a select collection of users, such as one or two mobile phones by the associated users of the client devices. For example, one of the members in the hub can be the designated control person, such as Mom who runs the household, employer, and so on.

From a single configuration of the members, the hub can be provisioned, setup, and propagated out, e.g., automatically. The features and configuration of a hub may default to an automatic, easy setup, but any rule, feature, or configuration aspect can be readily modified by a user. Provisioning a hub may be based on billing, e.g., a family or corporate billing plan. However, if a phone device is changed to a different carrier, for example, the phone device can still receive texts related to the hub. Alternatively or in addition, provisioning a hub can be based on email addresses, phone numbers, user account identifiers, or any other identifier.

A retail person selling a new phone package, for instance, can easily identify the members each to their new phone devices and initiate the hub being instantiated. From a consumer perspective, it just works and members can walk out of the store all set up. All of the data and information can be shared with a single selection, and thus the members do not have to share each item (e.g., a grocery list, photos, calendar, etc.) individually and separately.

The hub user interface may act as a shared space that is customizable and provides for user-generated and shared content. Some information can be shared, while other information is not. For example, Mom's complete Christmas list is not viewable by the other family members, but Dad and Kids can add to the list (and only view their contribution). Hub setup may be performed “a la carte,” meaning only the features that members want displayed on the hub wall can be selected. For example, Mom wants to see the shopping list, whereas Dad does not shop and so wants to avoid having the list displayed on his device, yet he could still access the shopping list to add items when desired.

The hub user interface integrates functions, calendar functionality, event and/or data summaries (i.e., on the “wall”), as well as content that is shared between the members of the hub (e.g., lists, documents, etc.). For example, the hub user interface may include a “family check-in” or “check-in” option. The hub user interface may also include a chat section where location check-ins messaged are displayed along with other messages interchanged between the members of the hub. The hub “wall” is representative of an area via which members of the group may add to as desired, like a lunchroom bulletin board, family refrigerator, and so on. In implementations, the information can be aggregated in pillars or columns and shown on the hub wall as illustrated. The hub wall can also represent an interrelation between any of the information and data that appears on the wall and its placement in time. The hub settings provide that a user can control which functions are integrated and displayed within the hub, such as on the wall.

The hub information may also be context relevant to the members of the hub, and the calendar includes shared hub events. Calendar updates can be posted as notice events on the wall, and a user can look at the wall to see upcoming hub events, or the events that pertain to one or more other members of the hub. Messaging may also be performed that is private among the members of the hub. A member can instant text (or other communication) to all other members in the hub. Texting—such as for a work meeting—can divide each members' display on their respective devices into individual screens for each member.

The hub may also be extensible, and may link to a hard drive on a home computer, or sync to just one of the other devices, the manager, or cloud control (e.g., from a network-based service). The hub may also be extensible to third parties that add a note on the hub wall, such as implemented with application program interfaces (APIs) for functions to post data to the hub. A third-party application, however, would not have access to the context of the hub wall, such as to obtain or display hub data. The private information and hub data could be encrypted and only decrypted by the phone devices that are associated with the hub.

Thus, the hub supported by the hub coordination architecture 112 may be thought of as a central space coordination of communications, activities, information, and integration of members of the hub. Hubs may be defined to support a variety of different membership, such as for family members, coworkers, friends, acquaintances, fan clubs, and so forth. Therefore, although examples are discussed that relate to a family in the following discussion it should be readily apparent that membership in the hub may be defined in a variety of other ways without departing from the spirit and scope thereof. Accordingly, the hub coordination architecture 112 may be used to support a variety of different functionality. An example of this functionality is illustrated as a hub check-in service 114 as further described below and shown in relation to the corresponding figure. Further aspects of hubs are also described further herein.

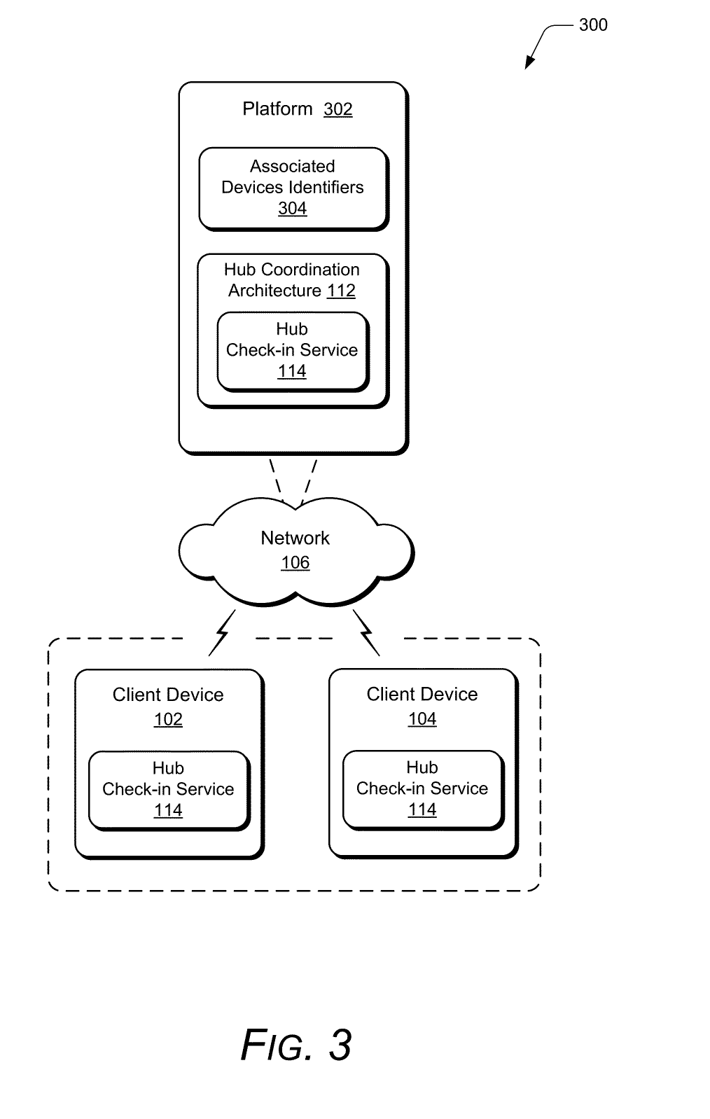

FIG. 3 depicts a system 300 in an example implementation in which the hub check-in service 114 of FIG. 1 is implemented “over the cloud” as part of a network service. As before, the client devices 102, 104 may avail themselves of functionality to a check-in service. In this instance, however, the hub check-in service 114 is illustrated as being available via the network 106. This may include availability as part of one or more web services implemented via a platform 302, as part of a provider of the network 106, and so on.

As described in relation to FIG. 1, the client devices 102 and 104 can each be associated with a different user, and the users are defined members of a hub, which may include two or more associated devices. The client devices each include an implementation of the hub check-in service 114 as described with reference to the previous FIGS. 1-2. In the example system 300, multiple devices can be interconnected through a central computing device or system, which may be local to the multiple devices or may be located remotely from the multiple devices.

In embodiments, the central computing device may be available via the network 106 “over the cloud” through one or more server computers that are connected to the multiple devices through a network, the Internet, or other data communication link. In embodiments, this interconnection architecture enables functionality across multiple devices to provide a networked service environment of the multiple devices. Each of the devices may have different physical configurations and capabilities, and the central computing device can utilize a platform 302 to maintain the associated devices identifiers 304, and implement all or portions of the hub coordination architecture 112 and/or the hub check-in service 114 in embodiments of client device check-in.

The platform 302 for the networked service components (e.g., the hub check-in service 114) that implements embodiments of client device check-in. The platform abstracts underlying functionality of hardware, such as server devices, and/or software resources of the cloud. The networked service components may include applications and/or data that can be utilized while computer processing is executed on servers that are remote from the client devices 102 and 104.

In embodiments, the hub check-in service 114 at the platform 302 is implemented to receive a check-in notification from client device 102 when a check-in notification is initiated by a user of the device. The check-in service can then determine associated devices of the device based on the associated devices identifiers 304 (and/or associated user identifiers), and communicate the check-in notification received from the client device 102 to the associated client device 104 (and to any other associated devices). The hub check-in service 114 can also modify the check-in notification, e.g., by converting a received location into a URL that has embedded information such as a user identity, device identity, a timestamp or time/date information, etc. Additionally, the check-in service can communicate the check-in notification (or a modification thereof) to the associated devices in multiple formats, such as a text message, an instant message, an audible message, or an image for display at the associated devices. The hub check-in service 114 at the platform 302 can also implement any of the embodiments and features of client device check-in as described herein.

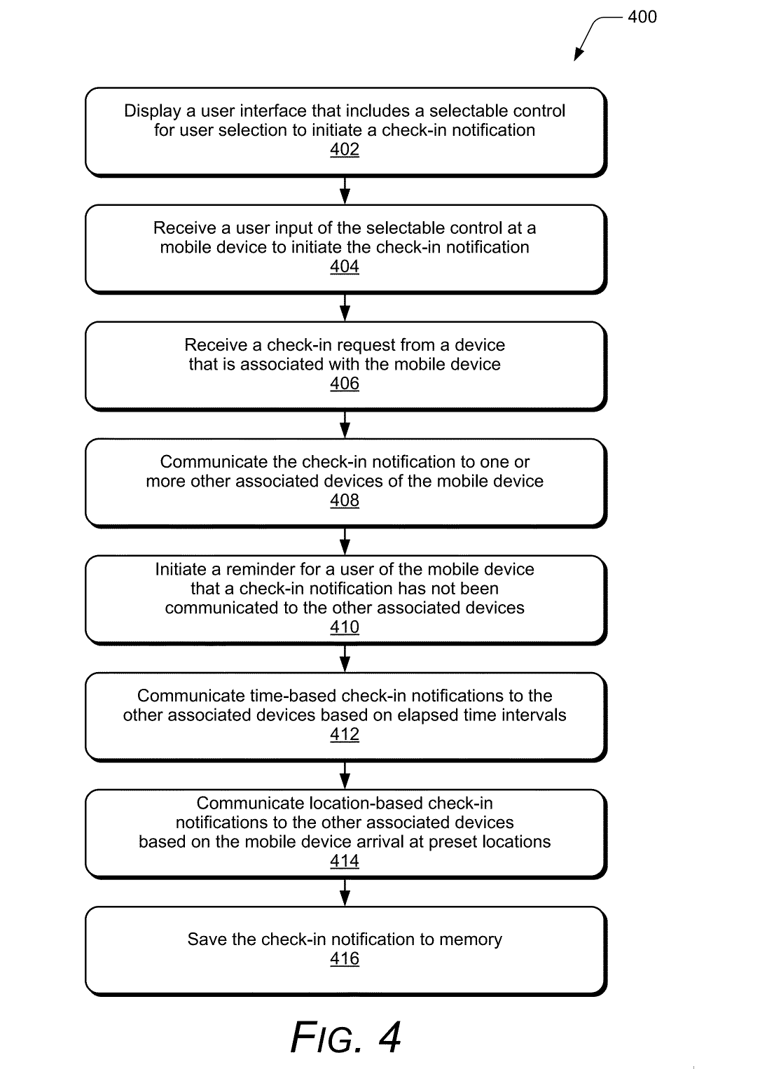

Example procedures 400, 500, and 600 are described with reference to respective FIGS. 4, 5, and 6 in accordance with one or more embodiments of mobile device check-in. Generally, any of the services, components, modules, methods, and operations described herein can be implemented using software, firmware, hardware (e.g., fixed logic circuitry), manual processing, or any combination thereof. Example methods may be described in the general context of executable instructions stored on computer-readable storage media that is local and/or remote to a computer processing system, and implementations can include software applications, programs, functions, and the like.

FIG. 4 illustrates an example procedure 400 of mobile device check-in. The order in which the method is described is not intended to be construed as a limitation, and any number or combination of the method operations can be combined in any order to implement a method, or an alternate method.

At 402, a user interface is displayed that includes a selectable control for user selection to initiate a check-in notification on a mobile device. For example, the client device 102 (FIG. 1) includes an integrated display device on which a user interface 116 is displayed (e.g., a hub user interface), and the user interface includes a check-in selectable control 118 for user selection to initiate a check-in notification. A check-in notification may indicate at least an identity of the device, the user, a date and time, and/or a location of the device.

At 404, a user input of the selectable control at the mobile device is received to initiate the check-in notification. For example, the hub check-in service 114 implemented at the client device 102 receives a user input to initiate a check-in notification, such as a touch selection of the selectable control 118 that is displayed on the user interface 116, or as a user input of the hardware selectable control 120 that may be implemented as a push button or switch on the device.

Optionally at 406, a check-in request is received from device that is associated with the mobile device (e.g., a different device than the mobile device). For example, the hub check-in service 114 implemented at the client device 102 receives a check-in request from the device 104 that is associated with the client device.

At 408, the check-in notification is communicated to one or more other associated devices of the mobile device. For example, hub check-in service 114 implemented at the client device 102 (e.g., the sending device) initiates communication of a check-in notification (e.g., via a communication interface of the device) to other associated devices (e.g., 104) of the device. A check-in notification can include an image of the location, a map of the location, displayable text, and/or a URL that provides a link to such information. A check-in notification can be generated as a Uniform Resource Locator (URL) that includes latitude, longitude, and a timestamp embedded in the URL. Alternatively or in addition, a check-in notification can include a user-selected formatted message that is communicated to the other associated devices. A check-in notification can be communicated to the other associated devices in multiple formats, such as a text message, an instant message, an audible message, or an image for display at the associated devices. A check-in notification can also be communicated when at least one of the associated devices is proximate the device at the location.

Optionally at 410, a reminder is initiated for a user of the mobile device that a check-in notification has not been communicated to the other associated devices. For example, the hub check-in service 114 implemented at the mobile device 102 initiates a reminder for a user of the mobile device that a check-in notification has not been communicated to associated devices for a certain time period or upon the occurrence of another predetermined condition, and the user can then initiate the check-in notification, such as described at 404.

At 412, time-based check-in notifications are communicated to the other associated devices of the mobile device based on elapsed time intervals. For example, the hub check-in service 114 implemented at the client device 102 initiates communication of time-based check-in notifications to the other associated devices (e.g., receiving device 104) based on elapsed time intervals, such as every hour or other defined time interval.

At 414, location-based check-in notifications are communicated from the mobile device to the other associated devices based on the mobile device arriving at preset locations. For example, the hub check-in service 114 implemented at the client device 102 initiates communication of location-based check-in notifications to the associated devices (e.g., receiving device 104) based on the mobile device arriving at preset locations.

At 416, a check-in notification is saved to memory of the mobile device and/or an associated device. For example, the hub check-in service 114 implemented at the client device 102 initiates saving check-in notifications to the memory of the mobile device, and the saved check-in notifications 126 are then reviewable, such as when displayed on the integrated display of the device.

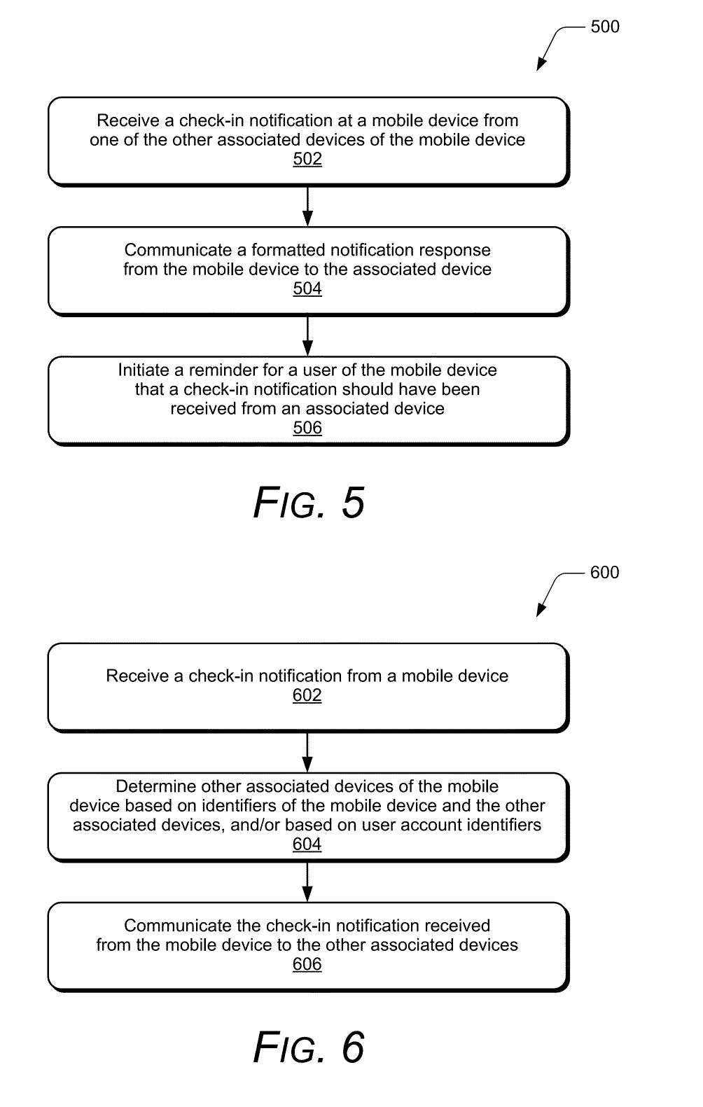

FIG. 5 illustrates example procedures 500 of client device check-in. The order in which the method is described is not intended to be construed as a limitation, and any number or combination of the method operations can be combined in any order to implement a method, or an alternate method.

At 502, a check-in notification is received at a mobile device from a device that is associated with the mobile device. For example, the check-in service 114 implemented at the client device 102 (FIG. 1) receives a check-in notification from an associated device. The hub check-in service 114 at the client device 102 can receive a check-in notification as a URL and perform a security and/or authenticity check of the received check-in notification in an effort to verify that the check-in notification has not been spoofed or tampered with.

At 504, a formatted notification response from the mobile device is communicated to the other associated device. For example, the hub check-in service 114 implemented at the first client device 102 initiates a formatted notification response back to the other associated device 104 responsive to receiving the check-in notification from the device. At 506, a reminder is initiated for a user of the mobile device that a check-in notification should have been received from the other associated device. For example, the hub check-in service 114 implemented at the mobile device 102 initiates a reminder for a user of the mobile device that a check-in notification should have been received from one of the associated devices.

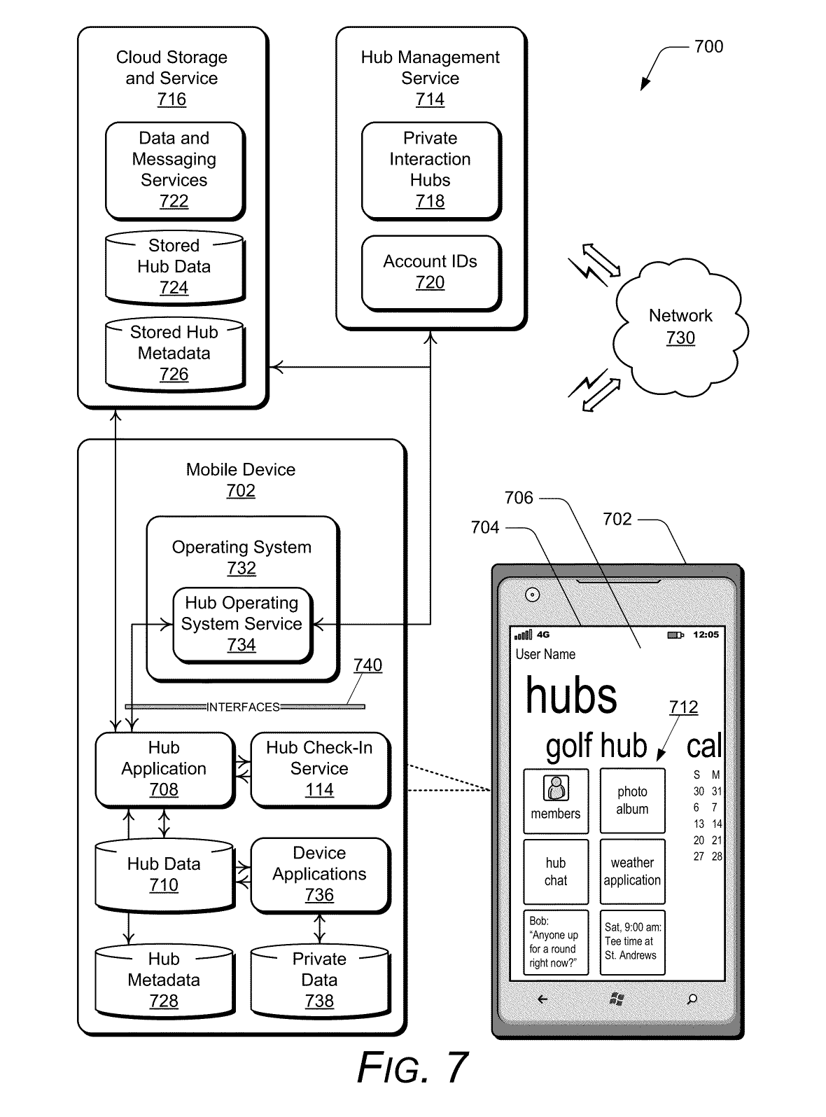

FIG. 6 illustrates example procedures 600 of client device check-in. The order in which the method is described is not intended to be construed as a limitation, and any number or combination of the method operations can be combined in any order to implement a method, or an alternate method.

At 602, a check-in notification is received from a mobile device. For example, the hub check-in service 114 implemented as part of the platform 302 (FIG. 3) receives a check-in notification from the client device 102 (e.g., a mobile device). The check-in notification can be received as a URL that includes latitude, longitude, and a timestamp embedded in the URL, where the combination of latitude and longitude identify a location of the mobile device. Optionally, the check-in notification may include an identifier of the mobile device from which the check-in notification is initiated and/or an identifier of the user of the mobile device. The check-in notification can be communicated to another client device 104 that is associated with the mobile device to inform a user of the other associated device.

At 604, other associated devices of the mobile device are determined based on identifiers of the devices and/or based on user account identifiers. For example, the hub check-in service 114 at the platform 402 determines the mobile device 102 and the other associated devices (e.g., client device 104) based on the associated devices identifiers 404 and/or based on user account identifiers. At 606, the check-in notification received from the mobile device (or a modified version thereof) is communicated to the other associated devices. For example, the hub check-in service 114 at the platform 402 initiates communication of the check-in notification that is received from the client device 102 to the associated device 104.

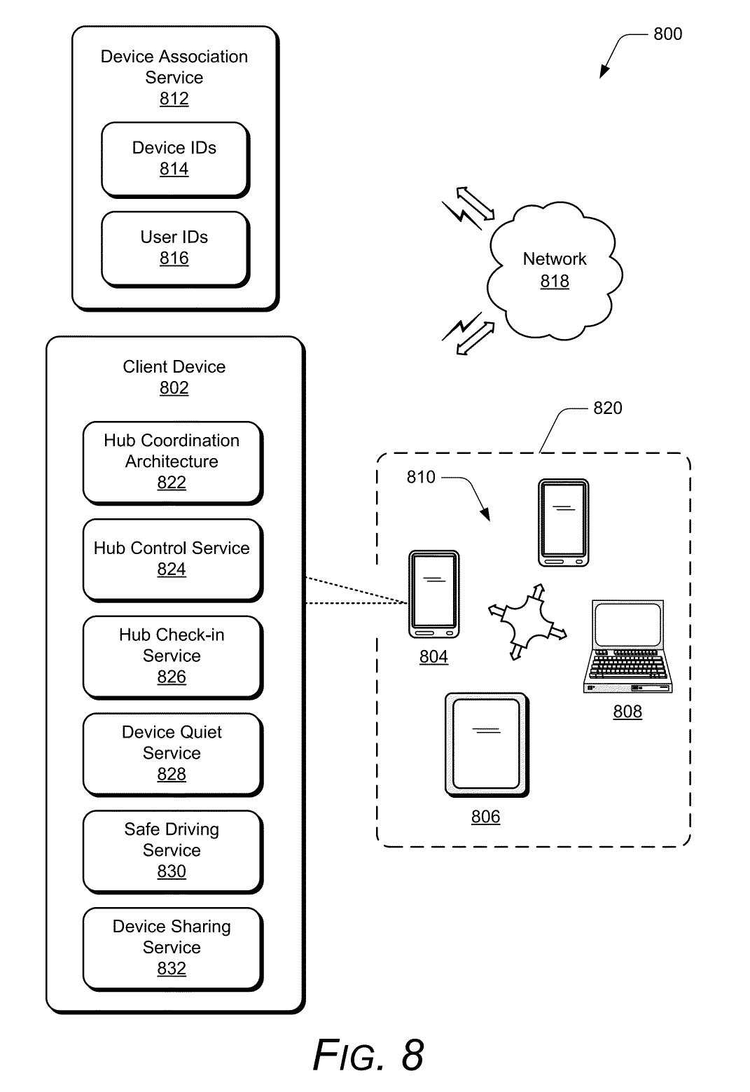

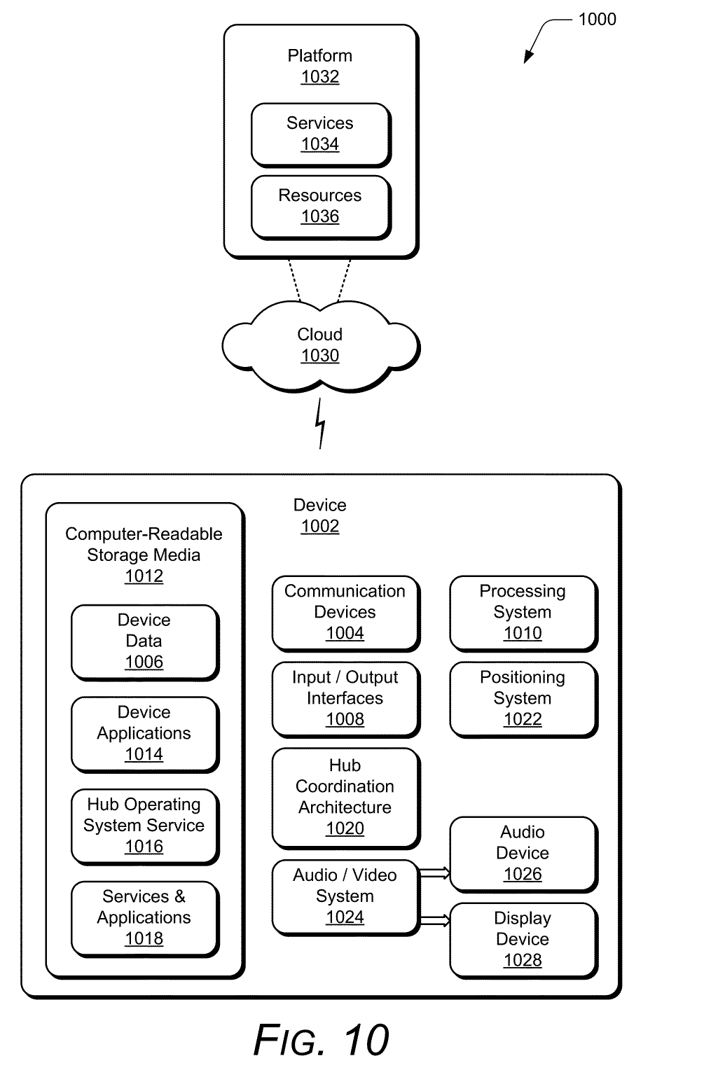

FIG. 7 illustrates an example system 700 in which embodiments of hubs can be implemented. The system 700 includes an example mobile device 702, which may be any one or combination of a wired or wireless device, such as a mobile phone, tablet, computing, communication, entertainment, gaming, media playback, and/or other type of device. Further, the mobile device 702 may be an example of one or more of the client devices as previously described. Any of the devices can be implemented with various components, such as a processing system and memory, as well as any number and combination of differing components as further described with reference to the example device shown in FIGS. 9, 10, and 11. As such, the mobile device 702 may implement techniques previously described in whole in or part, such as the techniques described in relation to the hub check-in service 114.

The mobile device 702 includes an integrated display device 704 on which user interfaces can be displayed, such as a hub user interface 706 of a hub application 708. The hub user interface offers a unified interactive view of the hub data 710 for a single, private interaction hub and the hub application 708 aggregates disparate types of the hub data 710 originating from the various member users of the private interaction hub. For example, the hub user interface may provide a single unified access point to shared hub messages, status updates, check-ins, hub calendar events, hub media, hub applications, and other types of hub content. As described above, a private interaction hub (or simply “hub” as discussed above) is a private network or association of member users who voluntarily elect to privately interact and collaborate with each other in a bi-directional manner. The hub data 710 includes any shared data or metadata that is used to facilitate the interaction and collaboration between the members of a private interaction hub, and may include shared data for messaging, notes, contact management, documents, tasks, location updates, photos, calendar events, applications (to include collaborative gaming applications), and/or other media content, such as any type of audio, music, video, and/or image data that may be available or accessed from any source.

The basic functionality of an example private interaction hub is shown as a golf hub displayed in the hub user interface 706 of the hub application 708. For example, the hub user interface can include various selectable user interface tiles 712, such as a members tile that is selectable to initiate a display of the constituent members of the private interaction hub. The user interface tiles 712 may also include hub chat and/or messages tiles to allow a hub member to participate in shared messaging threads with the other member users of the hub. For example, as shown, the member “Bob” has asked “Anyone up for a round right now?” The user interface tiles 712 may also include a photo album tile that is selectable to view photos shared by any of the hub members with the hub, and a shared notebook tile from which the hub members can view shared notes. For example, the golf hub may include a shared notes document that compiles the hub members' collective research of new golf equipment. The hub user interface 706 may also display a shared calendar that allows a member of the hub to view, edit, and post calendar events that will be shared with all of the other hub members. For example, the calendar tile shows an upcoming tee time at St. Andrews on Saturday at 9:00 a.m. for all of the members. When a user selects a group item (e.g., the message from Bob) or tile (e.g., the messaging tile), further details about the selected item or group items related to the selected tile may be displayed by the hub application itself or the hub application may call a different device application 736 (e.g., a messaging application) to display further details about the item(s).

When a user selects or otherwise engages with a piece of displayed hub data, such as the golf message from Bob, the hub application may provide additional details or options to the user to permit the user to interact further with the hub data. For example, the hub application may display controls to allow the user to edit or reply to Bob's message. Alternatively or in addition, when a user selects or otherwise engages with a piece of displayed hub data (e.g., Bob's message), the hub application may launch or call another device application to permit the user to further interact with the piece of hub data (e.g., the hub application may call a native messaging application).

The hub user interface 706 of the hub application 708 can also include user-selectable access to third-party applications, such as when an application is “pinned” to, or otherwise shared with a private interaction hub. A pinned third-party application may also utilize the shared hub data, such as shared application preferences or shared application state data. For example, the golf hub shown displayed in the hub user interface 706 includes a live tile representing a third-party weather application that the members of the hub can quickly access to check the weather forecast at their local golf club, such as when planning an upcoming golf outing. A user of the mobile device 702 can also customize display aspects of a hub user interface, such as the content of the user interface and how the elements of the hub user interface are arranged. Another example of a hub user interface of the hub application 708 is a panoramic hub user interface, such as for a family-centric private interaction hub as shown and described in greater detail with reference to FIG. 2.

The example system 700 also includes a hub management service 714, and a cloud storage and service 716. The hub management service 714 manages the formation and maintenance of private interaction hubs 718. The hub management service can correlate or associate member users of a hub by associating account identifiers 720 of the members with one or more of the private interaction hubs. The account identifier 720 of a member user may be associated with an identifier of a private interaction hub 718 in a data table that the hub management service maintains to correlate the hub members with one or more of the private interaction hubs. The hub management service 714 may also associate devices that correspond to hub members based on device identifiers. The account identifiers 720 can include user membership identifiers and/or sign-on credentials, such as an email and password combination, or a username and password combination. The sign-on credentials may be single sign-on (“SSO”) credentials that are utilized for authentication purposes at a number of Web services, including the cloud storage and service 716.

The cloud storage and service 716 can include any type of cloud-based (e.g., network-based) data and messaging services 722. The messaging services may include any type of email, text (e.g., SMS, MMS), and/or instant messaging services. The data services may include any type of calendar, photo album, file or document sharing, location, mapping, music sharing, video sharing, gaming, contacts management, and/or notebook services, as well as any other type of services that can be used to share stored hub data 724. The stored hub data can include any form of messages, updates, events, content, media, and information that is maintained for the private interaction hubs 718, and is accessible from the mobile device 702, either upon a request from a device and/or upon a data “push” to the device. The cloud storage and service 716 also maintains stored hub metadata 726 that includes settings and information pertaining to the private interaction hubs 718, such as the name of a hub, the background image or photo of the hub, and an association of the hub members.

Although shown together as data and messaging services 722, various application data services and various messaging services may be operated on separate devices and/or operated by separate, distinct entities. Additionally, although the hub management service 714 and the cloud storage and service 716 are shown as independent services, they may be implemented together as a single service. Further, a server device (or group of server devices) can include implementations of both the hub management service 714 and the cloud storage and service 716, representative of a single entity that may be the same server system, company system, domain, and the like.

The cloud storage and service 716, and its constituent data and messaging services 722, interchange the stored hub data 724 and the stored hub metadata 726 between the mobile devices that are associated with member users of a private interaction hub 718. For example, a data and/or messaging service of the cloud service 716 can receive a copy of hub data 710 and/or hub metadata 728 from the mobile device 702 that is used by a hub member, store this hub data and hub metadata in the cloud storage as the respective stored hub data 724 and stored hub metadata 726, and then distribute the stored hub data and stored hub metadata to other mobile devices associated with other member users of the same private interaction hub, as well as to other mobile devices associated with the same hub member. The stored hub metadata 726 can include membership information pertaining to the member users of a private interaction hub, hub identifiers that correlate a piece of hub data to a particular private interaction hub, user identifiers that correlate a piece of hub data to a particular member user, modification dates, and/or other metadata.

The cloud storage and service 716, and its constituent data and messaging services 722, may utilize single sign-on (“SSO”) credentials for authentication purposes to limit the dissemination of the stored hub data 724 and the stored hub metadata 726 to only the authorized devices of hub members. Additionally, any of the devices and services (e.g., implemented as server devices) described herein can communicate via a network 730, which can be implemented to include a wired and/or a wireless network. The network can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, mobile phone provider, and/or Internet service provider. Alternatively or in addition, peer-to-peer communication techniques may be utilized, such as multiple devices connected using a peer-to-peer communication network.

The mobile device 702 includes an operating system 732 of the device, and the operating system includes a hub operating system service 734 that is implemented to integrate cloud-based services, a hub application 708, and local device applications 736 with the operating system to implement aspects of the private interaction hubs 718. The aspects that may be implemented include hub formation and membership maintenance, synchronizing the hub data 710 on the mobile device with the stored hub data 724, and the hub metadata 728 with the stored hub metadata 726, with the cloud storage and service 716, and providing the hub application 708 and the local device applications 736 on the mobile device 702 with access to the hub data 710 and the hub metadata 728. For example, the hub operating system service 734 may directly access the stored hub metadata 726 at the cloud storage and service 716.

The hub operating system service 734 (or alternatively, the hub application 708) may also determine and maintain a local copy of the membership associations of member users account identifiers 720 and identifiers of the private interaction hubs. The hub operating system service 734 may also synchronize the stored hub data 724 from the cloud storage and service 716 with the hub data 710 at the mobile device 702, and synchronize the stored hub metadata 726 from the cloud storage and service with the hub metadata 728 at the mobile device. The hub operating system service 734 may also synchronize with the cloud storage and service 716 (e.g., by sending changes or additions to hub data 710 and hub metadata 728 to the cloud storage and service 716). Such data synchronizations may occur in response to a user launching the hub application.

The mobile device 702 includes the device applications 736 that permit a user of the mobile device to access, create, and/or modify the hub data 710, private data 738 of the user, as well as the stored hub data 724 that is managed by any of the data and messaging services 722 at the cloud storage and service 716. Some or all of the device applications 736 may be implemented as client-side components or modules of any of the data and messaging services 722, or may be implemented as standalone, native applications (e.g., local device applications) at the mobile device. The device applications 736 typically each consume and provide access to only a portion of the hub data 710 and the private data 738, such as only a single type of hub data and private data (e.g., only messaging data, but not calendar data). The device applications also typically present the consumed hub data to a user in conjunction with the private data 738. Private data is data or metadata that is not associated with a private interaction hub and that has not been shared with other members of the hub (e.g., data that has not been shared via the cloud storage and service 716).

The device applications 736 at the mobile device 702 may include a native or third-party messaging application that provides a user with messaging alerts and access to messaging threads. The messaging application provides access to both shared message threads shared with a private interaction hub and private message threads between a user of the mobile device and others who are not members of the hub. The messaging application also allows a user to send a message to all of the hub members without accessing a hub user interface of the hub application. The messaging application may not provide user access to other types of the hub data 710, other than the hub messages. For example, the messaging application may not provide access to the shared calendar events or shared photo albums of the hub.

The device applications 736 may also include a native or third-party calendaring application that provides scheduling alerts and access to a visual calendar. The calendaring application provides user access to both shared calendar events that are shared with hub members, and private calendar events (e.g., Exchange calendar events) that have not been shared with other members of the hub. The calendaring application also allows a user to create and/or share a calendar event to all members of the hub without accessing a hub user interface of the hub application. The application may not provide user access to other types of the hub data 710, other than the hub calendar events. For example, the calendaring application may not provide access to the shared message threads or shared photo albums of the hub.

The device applications 736 may also include a native or third-party media viewing and/or editing application that provides access to photo albums of digital photos or other digital media. The media application provides user access to both shared media files (e.g., photos, videos, and/or music) shared with a private interaction hub, and private media files that have not been shared with other members of the hub. The media application also allows a user to share media files with all members of the hub without accessing a hub user interface of the hub application. The media application may not provide user access to other types of hub data 710, other than hub media files. For example, the media application may not provide access to the shared message threads or shared calendar events of the hub.

The hub operating system service 734 can expose one or more Application Programming Interfaces (“APIs”), application binary interfaces, and/or other types of interfaces 740 to the hub application 708 and to the device applications 736 on the mobile device 702 to allow these applications to access, generate, and/or modify the hub data 710 and/or the hub metadata 728, as described herein. The hub operating system service 734 can be implemented as an integrated software component or module of the operating system 732. The hub operating system service can be maintained at the mobile device 702 as executable instructions that are stored on computer-readable storage media, such as any suitable memory device or electronic data storage as described with reference to the example device shown in FIG. 10. Additionally, the hub operating system service can be executed with a processing system at the mobile device to implement aspects of private interaction hubs.

In embodiments, the hub operating system service 734 can initiate the hub management service 714 to provision a private interaction hub 718. A user of the mobile device 702 can start a private interaction hub 718 and also invite others to join an existing private interaction hub. For example, the hub user interface 706 of the hub application 708 may provide an existing hub member with the option to add a new member to the hub, and the user may identify the prospective member by providing either a mobile device number, or by selecting an existing contact from one of their social networks or other contacts.

The hub operating system service 734 can receive the request from an existing member user of the device and, in response, the hub operating system service 734 and/or the hub management service 714 communicates an invitation to join the hub as an SMS, MMS, or instant message sent to the prospective member's mobile device that may include a link to a registration site or other registration instructions. The hub operating system service 734 and/or the hub management service 714 receives (e.g., via a registration website) an acceptance to the invitation to join the private interaction hub that includes at least an account identifier (such as an SSO credential), and associates the new member with the existing hub at the hub management service 714. Updated membership information, including the new member's account identifier 720 may also be propagated to other mobile devices of other members in the private interaction hub from the hub management service 714. When the new member user joins the hub, he or she may be prompted to download and/or install various applications configured to provide access to the stored hub data 724 and the stored hub metadata 726, such as the hub application 708 and/or the any of the device applications 736. The hub application 708 may also be the entry point by which a user creates a new hub and/or modifies the membership of an existing hub.

A private interaction hub 718 can be provisioned for any association of people, such as family members, coworkers, friends, neighbors, and any other people that may be associated together in a hub. Additionally, a member user of one private interaction hub may also be a member of multiple hubs, which can be based on a single member sign-on that identifies the member to the hub operating system service 734 and/or to the hub management service 714. For example, a person may be a member of a family hub that associates members of the person's family, as well as a member of a neighborhood hub that associates members of the person's neighborhood, and a golf hub that associates the person's friends that often golf together.

The integration of the hub application 708 with the operating system 732 of the mobile device provides that a user of the device can view a message or update on the hub user interface 706 and in an application user interface of an application that is associated with the message or the update. For example, a hub calendar is integrated with the calendar application (e.g., a device application 736) on the mobile device 702, and a calendar update that is displayed in the hub user interface 706 can be selected by the user to initiate the update being displayed in a calendar user interface of the calendar application. Alternatively, the user may view the calendar user interface and select a calendar event that is associated with a private interaction hub to initiate a display of the hub calendar, which includes the calendar event for the members of the hub. As another example, a hub calendar event can be displayed in a hub user interface, and the device calendar application can access and display the hub calendar event along with any private data calendar events that only the user of the device has access to view in a user interface of the device calendar application. The hub application 708 and the device application 736 both acquire the same hub calendar event data (e.g., the same hub data 710 stored on the mobile device). The two different user interfaces (e.g., a hub user interface and a device application user interface) display the same calendar event data.

In another example, the hub messages and chat features are integrated with messaging applications (e.g., the device applications 736) on the mobile device 702, and an email, text, or instant message that is displayed in the hub user interface 706 can be selected by the user of the mobile device 702 to initiate the message being displayed in a messaging application user interface. Alternatively, the user may view a recent message from a member of a private interaction hub in a messaging application user interface, and select the message to initiate a display of the hub messages interface, such as to view the discussion thread associated with the recent message.

In embodiments, the hub operating system service 734 at the mobile device 702 can receive social network updates for the member users of a private interaction hub 718, such as when two or more of the members of a hub are also “friends” on a public social network site, such as (e.g., FACEBOOK®, TWITTER®, or LINKEDIN®). The social network updates can be pulled from a social network site based on the established association of the account identifiers 720 of the hub members of a private interaction hub 718 at the hub management service 714. The hub operating system service 734 can then aggregate the social network updates for a particular hub for display in the hub user interface 706 or on a homepage “live tile” associated with the hub. The hub operating system service 734 at the mobile device 702 can also be implemented to coordinate multi-user interactive updates to an event that is managed in a private interaction hub. For example, several members of a hub may participate in a multi-player interactive game, and each successive interactive update from a member of the hub is initiated by the member at a respective associated mobile device.

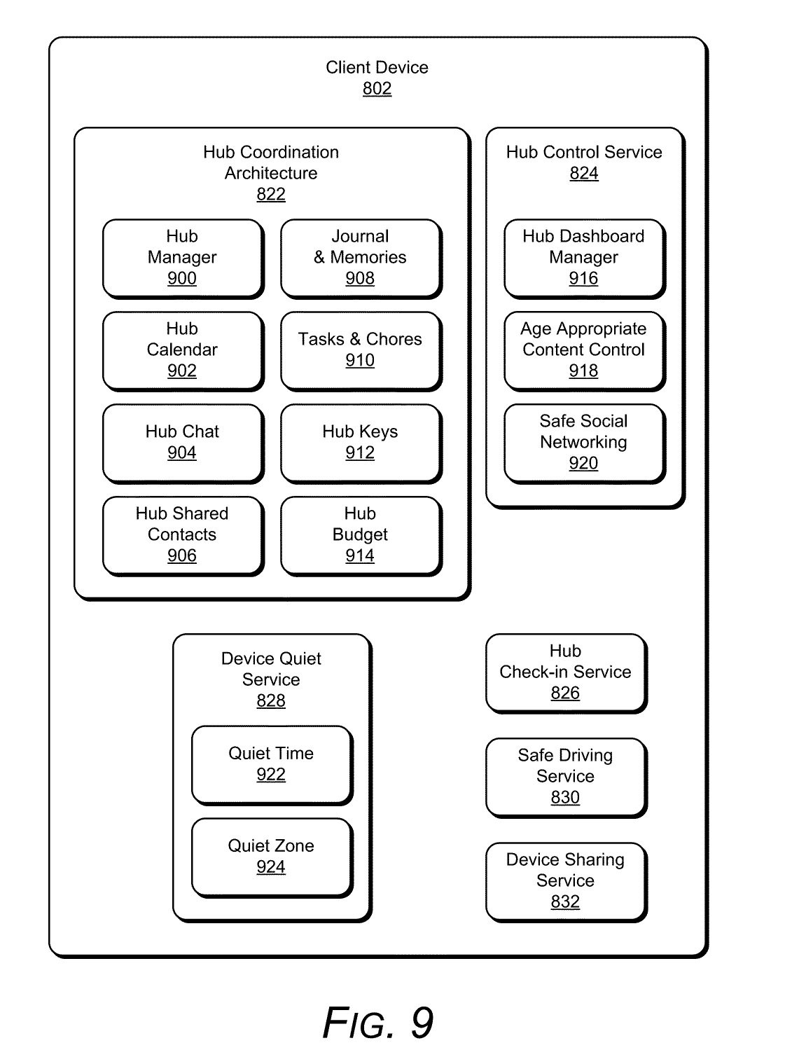

FIG. 8 illustrates an example system 800 in which various embodiments of the previously described techniques can be implemented. The example system includes a client device 802, which may be any one or combination of a mobile phone 804, tablet device 806, computing device 808, communication, entertainment, gaming, navigation, and/or other type of portable electronic device as previously described. Any of the client devices 810 can be implemented with various components, such as a processor and/or memory system, as well as any number and combination of differing components as further described with reference to the example device shown in FIG. 10 to implement embodiments of the techniques described herein.

The example system 800 includes a device association service 812 that associates or correlates the client devices 810 by device identifiers 814, user identifiers 816, and/or by any other type of identifiable association. Any of the devices and services can communicate via a network 818, which can be implemented to include wired and/or wireless networks. The network can also be implemented using any type of network topology and/or communication protocol, and can be represented or otherwise implemented as a combination of two or more networks, to include IP-based networks and/or the Internet. The network may also include mobile operator networks that are managed by mobile operators, such as a communication service provider, cell-phone provider, and/or Internet service provider. A mobile operator can facilitate mobile data and/or voice communication for any type of a wireless device or mobile phone.

The client devices 810 can each be associated with a different user, and the users are defined members of a hub 820. The example client device 802 is representative of the various client devices 810 in the hub. Any of the client devices in the family can include services, such as software applications (e.g., computer-executable instructions), that can be executed by a processor or processor system to implement the embodiments described herein. In this example, the client device 802 includes a hub coordination architecture 822 that implements features of a hub; a hub control service 824 that implements features of a hub dashboard; a hub check-in service 826; a device quiet service 828 that implements features of quiet time and quiet zone; a safe driving service 830; and a device sharing service 832.

Additionally, any one or combination of the various client device services may be abstracted for implementation by a network service provider, such as the device association service 812. For example, the client devices 810 that are associated in the hub 820 can be interconnected through a central computing device or system (e.g., may be one of the client devices 810), which may be local to the multiple devices or may be located remotely from the devices. In embodiments, the central computing device may be a cloud service of one or more server computers that are connected to the multiple devices via the communication network 818 or other communication link. The interconnection architecture enables functionality across multiple devices to provide a common and seamless experience to a user of the multiple devices. Each of the client devices may have different physical configurations and capabilities, and the central computing device implements a platform to enable delivery of an experience that is both tailored to a particular device and yet common to all of the devices.

FIG. 9 further illustrates the various client device services that are described with reference to the previous sections. The client device 802 includes the hub coordination architecture 822, the hub control service 824, the hub check-in service 826, the device quiet service 828, the safe driving service 830, and the device sharing service 832. In embodiments, the hub coordination architecture 822 may generally be implemented as a service, as described herein. Generally, any of the described services may be implemented and/or described in the general context of software, firmware, hardware (e.g., fixed logic circuitry), manual processing, applications, routines, programs, objects, components, data structures, procedures, modules, functions, or any combination thereof. A software implementation represents program code that performs specified tasks when executed by a computer processor. In embodiments, any of the processing, computation, filtering, code execution, etc. can be implemented with distributed computing services and/or devices, such as on a client device, a server device, and/or network-based service.

In this example of the client device services, the hub coordination architecture 822 includes a hub manager 900 that implements, coordinates, and/or manages various hub features, such as hub calendar 902, hub chat 904, hub shared contacts 906, hub journal and memories 908, tasks and chores 910, hub keys 912, and hub budget 914. The hub control service 824 implements features such as a hub dashboard manager 916, age appropriate content control 918, and safe social networking 920. The device quiet service 828 implements features such as quiet time 922 and quiet zone 924. The various client device services and features are further described throughout the document.

Any of the client device services can include, be integrated with, or implement any of the other client device services and applications. For example, the hub coordination architecture 822 can include any one or combination of the hub control service 824, the hub check-in service 826, the device quiet service 828, the safe driving service 830, and the device sharing service 832. In embodiments, the hub coordination architecture 822 may be implemented for the coordination of time, messaging, data, activities, and any other shared services. The shared services may be any of the client device services and/or any type of shared services that may be associated with a service and/or multi-system operator (MSO) devices. Further, the hub control service 824 can be implemented to throttle, expand, manage, and/or reallocate data sharing of the client device services. Any of the hub features and/or applications of the hub coordination architecture can be implemented as private, some private and some public, or private with optional user control to share information and data with public third-party services and applications. Similarly, any of the client device services and applications described herein may be private, public, sharable, user-controllable, and/or any combination thereof.

FIG. 10 illustrates an example system 1000 that includes an example device 1002, which can implement embodiments of private interaction hubs. The example device 1002 can be implemented as any of the devices, services, and/or servers previously described, such as any type of client or mobile device (e.g., mobile phone, tablet, computing, communication, entertainment, gaming, media playback, and/or other type of device). For example, the mobile device 102 shown in FIG. 1 may be implemented as the example device 1002.

The device 1002 includes communication devices 1004 that enable wired and/or wireless communication of device data 1006, such as media content and the shared messages, updates, and events data at the device. The media content can include any type of audio, video, and/or image data. The communication devices 1004 can also include transceivers for cellular phone communication and/or for network data communication.

The device 1002 also includes input/output (I/O) interfaces 1008, such as data network interfaces that provide connection and/or communication links between the device, data networks, and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of audio, video, and/or image data received from any content and/or data source.

The I/O interfaces 1008 also support natural user interface (NUI) inputs to the device 1002, such as any interface technology that enables a user to interact with a device in a “natural” manner, free from artificial constraints imposed by input devices such as mice, keyboards, remote controls, and the like. Examples of natural user interface inputs may rely on speech recognition, touch and stylus recognition, gesture recognition on-screen and motion gesture recognition proximate the device, head, eye, and environment recognition and tracking, augmented reality and virtual reality systems, and any other type of audible, vision, touch, gesture, and/or machine intelligence that may determine user input intentions.

The device 1002 includes a processing system 1010 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 1002 may further include any type of a system bus or other data and command transfer system that couples the various components within the device. A system bus can include any one or combination of different bus structures and architectures, as well as control and data lines.

The device 1002 also includes computer-readable storage media 1012, such as data storage devices that can be accessed by a computing device, and that provide persistent storage of data and executable instructions (e.g., software applications, programs, functions, and the like). Examples of computer-readable storage media include volatile memory and non-volatile memory, fixed and removable media devices, and any suitable memory device or electronic data storage that maintains data for computing device access. The computer-readable storage media can include various implementations of random access memory (RAM), read-only memory (ROM), flash memory, and other types of storage media in various memory device configurations.

Generally, computer-readable storage media is representative of media and/or devices that enable persistent and/or non-transitory storage of data in contrast to mere signal transmission, carrier waves, or signals per se. A computer-readable signal media may refer to a signal-bearing medium that transmits instructions, such as via a network. The signal media can embody computer-readable instructions as data in a modulated data signal, such as carrier waves or other transport mechanism.

The computer-readable storage media 1012 provides storage of the device data 1006 and various device applications 1014, such as an operating system that is maintained as a software application with the computer-readable storage media and executed by the processing system 1010. In this example, the device applications also include an hub operating system service 1016 that implements embodiments of private interaction hubs, such as when the example device 1002 is implemented as the client device 802 shown in FIG. 8. An example of the hub operating system service 1016 is the hub operating system service 824 that is integrated with the operating system 822 at the mobile device 802, as described with reference to FIG. 8.

The device applications 1014 can also include any of the hub services and applications 1018 that implement embodiments of private interaction hubs and/or mobile devices family coordination, such as described with reference to FIGS. 8-10. The example device 1002 also includes a hub coordination architecture 1020, which may be implemented in the general context of software, firmware, hardware (e.g., fixed logic circuitry), or any combination thereof to support embodiments of private interaction hubs and/or mobile devices family coordination. The device 1002 can also include a positioning system 1022, such as a GPS transceiver, or similar positioning system components, that can be utilized to determine a global or navigational position of the device.

The device 1002 also includes an audio and/or video system 1024 that generates audio data for an audio device 1026 and/or generates display data for a display device 1028. The audio device and/or the display device include any devices that process, display, and/or otherwise render audio, video, display, and/or image data. In implementations, the audio device and/or the display device are integrated components of the example device 1002. Alternatively, the audio device and/or the display device are external, peripheral components to the example device.

In embodiments, at least part of the techniques described for private interaction hubs may be implemented in a distributed system, such as over a “cloud” 1030 in a platform 1032. The cloud 1030 includes and/or is representative of the platform 1032 for services 1034 and/or resources 1036. For example, the services 1034 may include the hub management service 708 and the cloud service and storage 716 as described with reference to FIG. 7. Additionally, the resources 1036 may include any of the messaging applications and the collaborative applications as described previously.

The platform 1032 abstracts underlying functionality of hardware, such as server devices (e.g., included in the services 1034) and/or software resources (e.g., included as the resources 1036), and connects the example device 1002 with other devices, servers, etc. The resources 1036 may also include applications and/or data that can be utilized while computer processing is executed on servers that are remote from the example device 1002. Additionally, the services 1034 and/or the resources 1036 may facilitate subscriber network services, such as over the Internet, a cellular network, or Wi-Fi network. The platform 1032 may also serve to abstract and scale resources to service a demand for the resources 1036 that are implemented via the platform, such as in an interconnected device embodiment with functionality distributed throughout the system 1000. For example, the functionality may be implemented in part at the example device 1002 as well as via the platform 1032 that abstracts the functionality of the cloud 1030.

Although embodiments of client device check-in have been described in language specific to features and/or methods, the appended claims are not necessarily limited to the specific features or methods described. Rather, the specific features and methods are disclosed as example implementations of mobile device check-in.

1. A mobile device, comprising:
a communication interface configured for communicating with one or more other devices associated with the mobile device;
a selectable control configured for user selection to initiate a check-in notification that indicates at least a location of the mobile device and a timestamp of the date and time; and
a processing system to implement computer instructions as a check-in service that is configured to initiate communication of the check-in notification to the one or more other associated devices responsive to the user selection to initiate the check-in notification.

2. A mobile device as recited in claim 1, further comprising a user interface configured for display on an integrated display of the mobile device, wherein the selectable control is displayed for touch selection on the user interface.

3. A mobile device as recited in claim 1, wherein the check-in service is configured to:
receive a check-in request from one of the other associated devices to initiate the check-in notification; and
initiate communication of the check-in notification to the one or more other associated devices responsive to the check-in request.

4. A mobile device as recited in claim 1, wherein the check-in service is configured to initiate communication of the check-in notification to the one or more other associated devices in multiple formats that include at least one of a text message, a message that includes a URL, an instant message, an audible message, or an image for display at the one or more associated devices.

5. A mobile device as recited in claim 1, wherein the check-in notification includes at least one of an image of the location, a URL, a map of the location, or displayable text.

6. A mobile device as recited in claim 1, wherein the check-in service is configured to save the check-in notification to the memory, and wherein the saved check-in notification is reviewable.

7. A mobile device as recited in claim 1, wherein the check-in notification includes a user-selected formatted message configured for communication to the one or more other associated devices.

8. A mobile device as recited in claim 1, wherein the check-in service is configured to initiate a reminder for a user of the mobile device that the check-in notification has not been initiated for communication to the one or more other associated devices.

9. A mobile device as recited in claim 1, wherein the check-in service is configured to initiate communication to the one or more other associated devices at least one of:
time-based check-in notifications based on elapsed time intervals; or
location-based check-in notifications based on the mobile device arrival at preset locations.

10. A mobile device as recited in claim 1, wherein the check-in service is configured to initiate communication of the check-in notification when at least one of the other associated devices is proximate the device at the location.

11. A mobile device as recited in claim 1, wherein the check-in service is configured to:
receive a separate check-in notification from one of the other associated devices; and
initiate communication of a formatted notification response to the other associated device responsive to receiving the separate check-in notification.

12. A mobile device as recited in claim 1, wherein the check-in service is configured to initiate a reminder for a user of the mobile device that a separate check-in notification should have been received from one of the other associated devices.

13. A method, comprising:
displaying a user interface that includes a selectable control for user selection to initiate a check-in notification that indicates a location of a mobile device and a timestamp of the date and time;
receiving a user input of the selectable control to initiate the check-in notification; and
communicating the check-in notification to one or more other associated devices of the mobile device.

14. A method as recited in claim 13, further comprising:
receiving a check-in request from one of the other associated devices to initiate the check-in notification; and
initiating communication of the check-in notification to the one or more other associated devices responsive to the check-in request.

15. A method as recited in claim 13, wherein the check-in notification is communicated to the one or more other associated devices in multiple formats that include at least one of a text message, a message with a URL, an instant message, an audible message, or an image for display at the one or more other associated devices.

16. A method as recited in claim 13, further comprising:
initiating a reminder for a user of the mobile device that the check-in notification has not been communicated to the one or more other associated devices.

17. A method as recited in claim 13, further comprising at least one of:
communicating time-based check-in notifications to the one or more other associated devices based on elapsed time intervals; or
communicating location-based check-in notifications to the one or more other associated devices based on the device arrival at preset locations.

18. A method as recited in claim 13, wherein the check-in notification includes a user-selected formatted message that is communicated to the one or more other associated devices.

19. A check-in system, comprising:
a network service device to execute computer instructions as a check-in service that is configured to:
receive a check-in notification from a mobile device when the check-in notification is initiated by a user of the mobile device, the check-in notification indicating a location of the mobile device and a timestamp of the date and time;
determine one or more other devices associated with the mobile device based on identifiers of the mobile device and the one or more other associated devices; and
communicate the check-in notification received from the mobile device to the one or more other associated devices.

20. A check-in system as recited in claim 19, wherein the check-in service is configured to communicate the check-in notification to the one or more associated devices in multiple formats that include at least one of a text message, an instant message, a message with a URL, an audible message, or an image for display at the one or more associated devices.
